(19) United States
(12) Patent Application Publication
(10) Pub. No.: US 2009/0309252 A1
(43) Pub. Date: Dec. 17, 2009

(54) METHOD OF CONTROLLING EVAPORATION OF A FLUID IN AN ARTICLE

(75) Inventors: James E. Schuetz, Sanford, MI (US); Thomas W. McCullough, Lake Jackson, TX (US); Neil Anderson, Calumet, MI (US); Justin LaCosse, Calumet, MI (US); Thomas D. Wood, Houghton, MI (US)

Correspondence Address: HOWARD & HOWARD ATTORNEYS PLLC, 450 West Fourth Street, Royal Oak, MI, 48067, US

(73) Assignee: CENTURY, INC., Traverse City, MI (US)

(21) Appl. No.: 12/174,996

(22) Filed: Jul. 17, 2008

Related U.S. Application Data
(60) Provisional application No. 61/132,281, filed on Jun. 17, 2008.

(51) Int. Cl. B01D 71/00

(52) U.S. Cl. 264/79

(57) ABSTRACT

A method of controlling evaporation of a fluid, such as water, in an article includes the step of encapsulating the article with a film such that the fluid is prevented from evaporating from the article. The method further includes the step of heating the article encapsulated with the film to a first desired temperature for a first period of time while preventing the fluid from evaporating from the article. The method also includes the step of removing the film from the article after heating the article to the first desired temperature for the first period of time and, after the step of removing the film the article, the method includes the step of further heating the article to a second desired temperature for a second period of time while the fluid freely evaporates from the article.

### RELATED APPLICATIONS

This application claims priority to and all advantages of U.S. Provisional Patent Application No. 61/132,281, which was filed on Jun. 17, 2008.

### BACKGROUND OF THE INVENTION

1. Field of the Invention

The present invention generally relates to a method of curing an article and, more particularly, to a method of curing an article by controlling evaporation of a fluid from the article.

2. Description of the Related Art

Methods of curing are known in the art and are utilized to form desired end products having different physical and/or chemical properties than beginning materials. Some beginning materials do not require any affirmative step during curing to form end products, such as polyurethanes. Additionally, methods of curing can include steps of applying heat, pressure, radiation, electron beam, addition of additives, etc. Methods of curing are employed to form a variety of end products, such as ceramics, rubbers, silicones, etc.

The method of curing can have several different effects on the beginning material. In one instance, a chemical reaction within the beginning material may occur instantaneously or evolve over time, thereby cross-linking the beginning material to form the end product. In another instance, the step of applying heat can induce evaporation of water to reduce and/or eliminate voids within the beginning material.

Oftentimes beginning materials are shaped in a mold prior to or during curing. The mold can contribute to curing the beginning materials by transferring heat and/or pressure to the beginning materials disposed within the mold. However, the beginning material can stick to a surface of the mold, thereby creating additional drawbacks when trying to remove the beginning materials or the end products from the mold. Mold release agents, for example, thin films or lubricating agents, are employed to prevent the beginning material from sticking to the surface of the mold. Mold release agents generally remain in the mold and increase longevity of the mold by reducing wear and damage to the surface of the mold.

Further, when the method of curing requires a substantial amount of time, it is inefficient and expensive to cure the beginning material in the mold. One attempt to resolve this is illustrated in U.S. Pat. No. 4,702,877 to Davis, wherein a secondary mold is formed from a plastic within a primary mold. The plastic is disposed within the primary mold to form the secondary mold, and the beginning material is disposed therein. The secondary mold is then removed from the primary mold having the beginning material disposed therein whereby the beginning material is cured via evaporation outside of the primary mold. This process allows for increased production through need for fewer primary molds; however, allowing evaporation of the beginning material while disposed in the secondary mold, which has an open mold cavity, can only be used to cure limited beginning materials, such as concrete.

When the beginning material is cured outside of the mold by evaporation, whether at ambient conditions or in a heating chamber, the beginning material may reduce in size as the water evaporates. Ceramic, for example, cures by evaporation and undergoes shrinkage during curing. Water molecules near the surface of the ceramic evaporate faster than a rate at which water molecules within the ceramic migrate to the surface of the ceramic. The difference between the rate of evaporation near the surface and the rate of migration of the water within the ceramic creates warping and non-uniform shaping of the ceramic. An attempt to mitigate this drawback is illustrated in U.S. Pat. No. 6,539,644 to Araya, wherein a honeycomb ceramic substrate is covered with a film to retard the rate of evaporation such that the rate of evaporation is substantially similar to the rate of migration of water to the surface of the honeycomb ceramic substrate to prevent warping. However, this attempt still allows water to evaporate from the beginning material and, therefore, there remains an opportunity to provide for a further method of controlling evaporation during curing of the beginning material to form the end product.

Accordingly, it would be advantageous to provide for a method of curing a beginning material, e.g., an article, to form a desired end product having different properties than the beginning material by controlling evaporation of fluids, such as water, from the beginning material during curing. It would be further advantageous to provide for the method that substantially inhibits evaporation of the water during the curing of the beginning material until a desired temperature is maintained within the beginning material, at which point the water is allowed to evaporate from the beginning material.

### SUMMARY OF THE INVENTION AND ADVANTAGES

The present invention provides a method of controlling evaporation of a fluid from an article. The method includes the step of encapsulating the article with a film to prevent the fluid from evaporating from the article. The method also includes the step of heating the article to a first desired temperature for a first period of time while preventing the fluid from evaporating from the article. The method further includes the step of removing the film from the article and the step of further heating the article to a second desired temperature for a second period of time such that the fluid can evaporate from the article sufficient to dry the article.

The method can be used to make end products, such as a ceramic article, e.g. a ceramic preform, and the method allows for the evaporation of fluids, such as water, from the article to be controlled such that the end products have excellent physical properties. The excellent physical properties include, for example, excellent strength, excellent wear resistance, and excellent shape retention, i.e., minimal distortion.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an article;

FIG. 2 is a perspective view of a cured ceramic article;

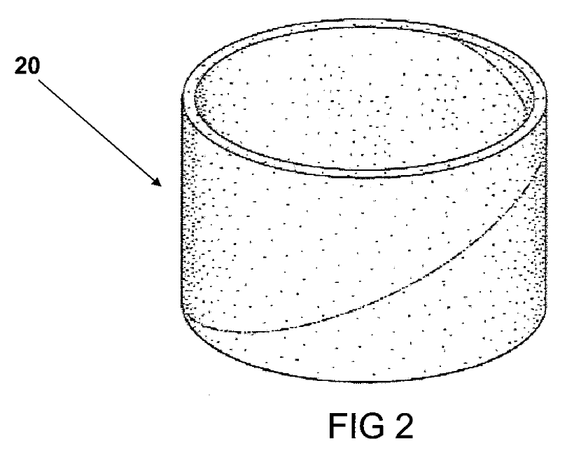

FIG. 3 is a perspective view of an extruder for producing an extrudate to form the article;

FIG. 4 is a perspective view of an apparatus for disposing a film about the article in accordance with a method of the present invention;

FIG. 5 is a perspective view of a mold having a surface defining an open mold cavity and a rigid film disposed in the open mold cavity;

FIG. 6 is a perspective view of the mold having the film disposed across the open mold cavity of the surface of the mold;

FIG. 7 is a cross-sectional view of a mold having the article encapsulated with the film deposited therein; and

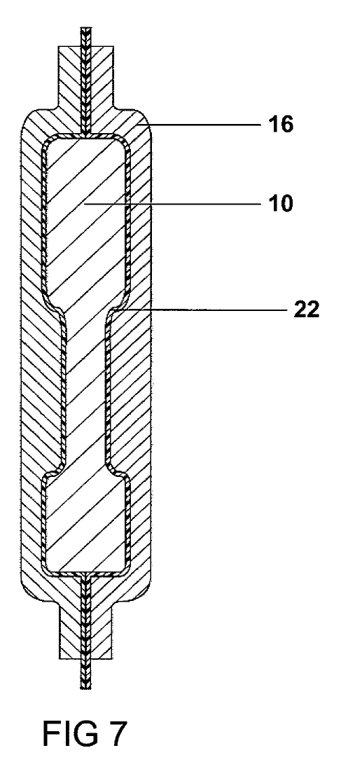

FIG. 8 is a perspective view of the article encapsulated with the film.

### DETAILED DESCRIPTION OF THE INVENTION

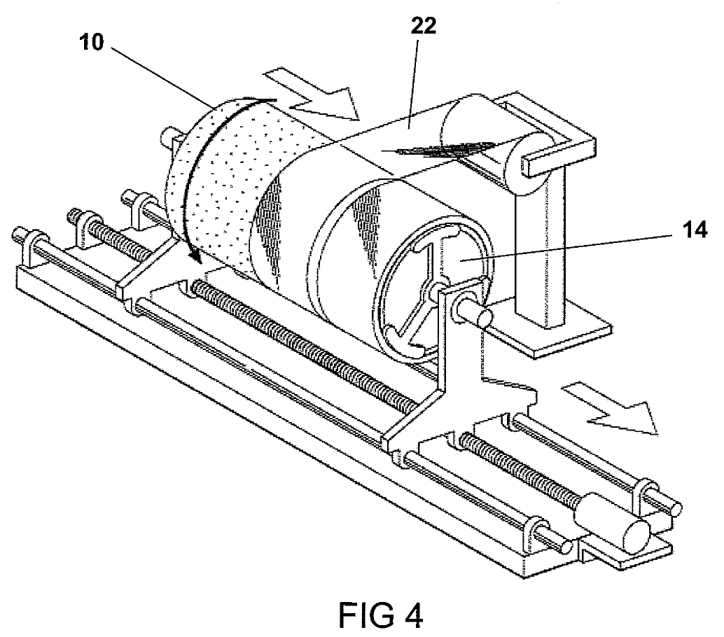

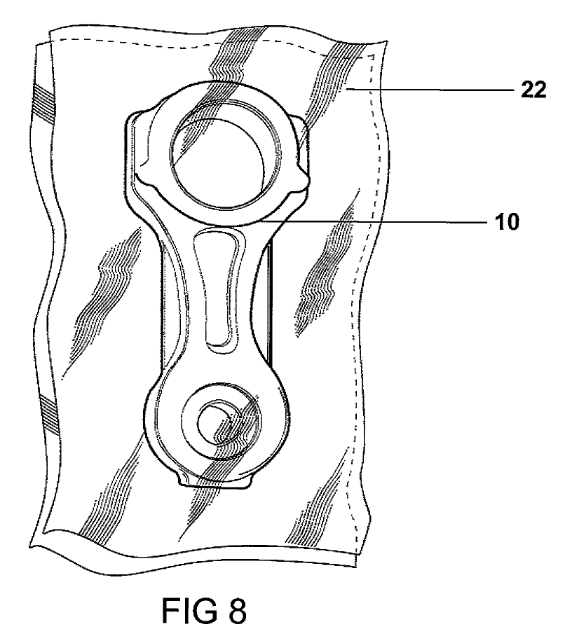

The present invention provides a method of controlling evaporation of a fluid from an article 10 as shown in FIGS. 4, 6 and 8. The method is suitable for curing articles to form end products, such as ceramic preforms, while controlling and/or preventing evaporation of fluids, such as water, therefrom. It is to be appreciated that the end products are not limited to ceramic preforms; the method may be used to control evaporation of fluids during heating of other articles, such as polymeric articles, without departing from the scope of the present invention. Further, the type of fluid being evaporated may be of any type of liquid, gel, solvent, additive component, organic binder or the like.

For the method, a composition is provided. The composition is typically formed into the article 10. That is, in one embodiment of the present invention, the composition is extruded to form an extrudate 12 which is typically processed to form the article 10. Alternatively, the article 10 may be provided.

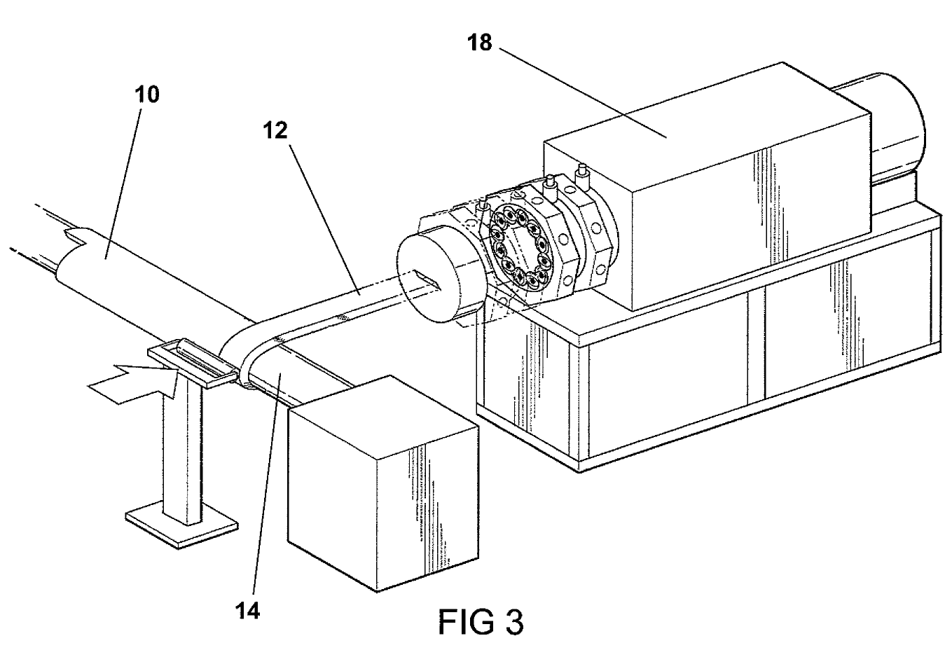

In embodiments in which the composition is extruded, the extrudate 12 may be processed to form the article 10 by any number of different means. In one embodiment, the extrudate 12 may be processed to form the article 10 by wrapping the extrudate 12 about a mandrel 14 to form a cylindrical article, as shown in FIG. 3. The details of such a process are disclosed in co-pending U.S. patent application Ser. No. ______ (H&H file no. 065109.00041). In another embodiment, the extrudate 12 may be processed to form the article 10 by providing a mold 16. In this embodiment, the step of processing the extrudate 12 to form the article 10 is further defined as depositing the extrudate 12 in the mold 16. The step further includes closing the mold 16 to shape the extrudate 12 into the article 10. It is to be appreciated that the article 10 may be provided or processed in any suitable fashion by any suitable means without departing from the scope of the present invention.

In a preferred embodiment, the article 10 is an uncured ceramic article. In this embodiment, the uncured ceramic article is formed from a ceramic extrudate. The ceramic extrudate can be provided after exiting an extruder 18, i.e., as an output of the extruder 18, or may be provided as set forth below. As shown in FIG. 3, the extruder 18 is preferably a multi-screw extruder having at least three intermeshing screws. The multi-screw extruder typically includes from 3 to 24, more typically from 10 to 12 screws formed in a ring configuration. That is, the multi-screw extruder is typically a ring extruder, as shown schematically in FIG. 3. The at least three intermeshing screws are typically arranged in fixed positions in the ring, are typically geared to the same motor, and typically rotate at the same speed. The at least three intermeshing screws may be co-rotating or counter-rotating.

The multi-screw extruder typically has a modular design and comprises solid barrels and/or combination barrels. The combination barrels typically include ports for injecting components or for venting volatile gases. One skilled in the art typically selects a combination of solid barrels and combination barrels to provide desired processing characteristics of the multi-screw extruder and desired physical properties of the extrudate 12.

The multi-screw extruder may also include flow blocking flights for providing separate mixing processes in the multi-screw extruder. The flow blocking flights may be flighted, and typically impede passing of the composition between sections of the multi-screw extruder. It is to be appreciated that certain flow blocking flights can be removed for increasing the feeding capability of the multi-screw extruder.

In one embodiment, the multi-screw extruder has elements with missing flights to increase an amount of material present in the multi-screw extruder. That is, certain flights are typically removed to a core of screw elements of the screw to increase the feeding capability of the multi-screw extruder.

The multi-screw extruder typically has from 2 to 8, more typically from 4 to 6 mixing zones. The multi-screw extruder also typically has an L/D ratio of 18 to 56, more typically 20 to 44. A suitable multi-screw extruder is the 3+ RingExtruder commercially available from Century, Inc. of Traverse City, Mich.

The at least three intermeshing screws of the multi-screw extruder typically rotate at from 20 to 1,200, more typically from 100 to 400 rpm. As the at least three intermeshing screws rotate, the composition is conveyed, mixed, and advanced through the multi-screw extruder until the composition exits the multi-screw extruder through a shaping die. It is to be appreciated that the ceramic extrudate may alternatively be provided by a means other than the extruder 18, e.g. a mixer.

In another embodiment, the article 10 is typically a polymeric article formed from a polymeric extrudate. The polymeric extrudate can likewise be provided after exiting the extruder 18, i.e., as the output of the extruder 18, or may be provided as set forth below. The polymeric extrudate may also alternatively be provided by a means other than the extruder 18, e.g. a mixer.

In the embodiment in which the article 10 is the uncured ceramic article, the uncured ceramic article typically comprises ceramic fibers having an aspect ratio of greater than 3:1 and ceramic particles. The ceramic fibers are also typically included in a cured ceramic article 20, i.e., a ceramic article, formed the uncured ceramic article as set forth in more detail below. The ceramic fibers are typically included in the cured ceramic article 20 to reduce the density, enhance metal infiltration, and optimize strength of the cured ceramic article 20, i.e., the ceramic article, formed from the uncured ceramic article. The ceramic fibers typically comprise an element from period 2, 3, 4, or 5 of the periodic table of the elements. Typically, the ceramic fibers comprise aluminum, silicon, oxygen, zirconium, or carbon. The ceramic fibers are typically selected from the group of alumina-silica fibers, alumina-silica-zirconia fibers, carbon-graphite fibers, and combinations thereof. Carbon-graphite fibers are typically selected for applications requiring the ceramic article to have high strength.

The ceramic fibers typically have an aspect ratio of greater than 3:1. In one embodiment, the ceramic fibers have an aspect ratio of greater than or equal to 5:1. In another embodiment, the ceramic fibers have an aspect ratio of greater than or equal to 10:1. It is to be appreciated that the term aspect ratio means a ratio of the longer dimension, i.e., length, of the ceramic fibers to the shorter dimension, i.e., diameter, of the ceramic fibers. The ceramic fibers typically have a length of from 5 to 500, more typically from 50 to 250 μm. The ceramic fibers typically have a diameter of from 1 to 20, more typically from 2 to 5 μm. Without intending to be limited by theory, it is believed that ceramic fibers having an aspect ratio of greater than 3:1 decrease the density of the ceramic article and optimize metal infiltration of the ceramic article by spacing out the ceramic particles. The ceramic fibers define void space between the ceramic particles, which allows metal to flow between the ceramic particles and substantially infiltrate the cured ceramic article 20 during fabrication of a metal matrix composite. The particulars of the formation of the metal matrix composite are disclosed in co-pending U.S. patent application Ser. No. ______ (H&H docket no. 065109.00044)

When the article 10 comprises the ceramic fibers, that is, in the embodiment when the article 10 is the uncured ceramic article, the method further comprises the step of substantially randomly orienting the ceramic fibers in three dimensions in the article 10. It is to be appreciated that the term substantially means that greater than 90 out of 100 ceramic fibers are randomly oriented in three dimensions in the article 10. It is further to be appreciated that the term randomly oriented means that adjacent ceramic fibers are disposed in different dimensions and that adjacent ceramic fibers are free from a pattern of alignment. More specifically, adjacent ceramic fibers oriented in different dimensions are typically present in the article 10 in an amount of greater than 85 parts by volume based on 100 parts by volume of the article 10. Further, adjacent ceramic fibers oriented in the same dimension are typically present in the article 10 in an amount of from 0.1 to 5 parts by volume based on 100 parts by volume of the article 10. Without intending to be limited by theory, it is believed that ceramic fibers substantially randomly oriented in three dimensions provide the ceramic article with uniform strength in three dimensions. As such, the ceramic article of the present invention is typically free from fatigue and/or failure in a third, non-reinforced dimension as compared to ceramic articles with ceramic fibers oriented in only two dimensions. In the preferred embodiment, the step of substantially randomly orientating the ceramic fibers is performed during the step of extruding the composition.

The ceramic fibers are typically substantially homogeneously dispersed in the ceramic article. It is to be appreciated that the term substantially means greater than 90 out of 100 ceramic fibers in the article 10 are homogeneously dispersed in the ceramic article. Further, it is to be appreciated that the term homogeneously dispersed means that greater than 85% by volume of the ceramic fibers in the ceramic article are uniformly distributed on a scale of twice the diameter of the ceramic fiber. That is, greater than 85 out of 100 ceramic fibers are spaced at least one ceramic fiber diameter away from an adjacent ceramic fiber. Without intending to be limited by theory, it is believed that ceramic fibers that are substantially homogeneously dispersed in the ceramic article provide the ceramic article with uniform density and, consequently, uniform strength. That is, the ceramic article is typically free from entanglements and conglomerations of ceramic fibers that cause weak points that typically decrease strength and stiffness of ceramic articles. Since the ceramic article exhibits uniform density, it is typically unnecessary to add additional ceramic fibers to the ceramic article after formation to remedy inconsistent density, thereby minimizing production costs of the ceramic article. Additionally, since the ceramic article of the present invention is typically free from blockages caused by entanglements and conglomerations of ceramic fibers, the ceramic article of the present invention also minimizes infiltration blockages caused by entanglement and conglomeration and enables excellent metal infiltration for efficient production of metal matrix composites.

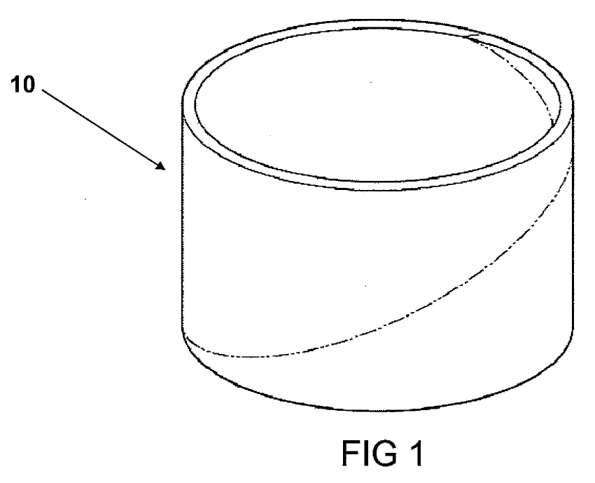

The uncured ceramic article, i.e., the ceramic article that has not been cured or sintered, is shown schematically in FIG. 1. During curing or sintering, any liquid components of the uncured ceramic article typically burn off, and solids remain in the ceramic article, as set forth in more detail below. That is, after curing or sintering, solids are typically present in the ceramic article in an amount of from 20 to 50 parts by volume based on 100 parts by volume of the ceramic article. Solids are more typically present in the ceramic article in an amount of from 30 to 40 parts by volume based on 100 parts by volume of the ceramic article. Air is typically present in the ceramic article in an amount of from 50 to 80 parts by volume based on 100 parts by volume of the ceramic article. Air is more typically present in the ceramic article in an amount of from 60 to 70 parts by volume based on 100 parts by volume of the ceramic article.

The ceramic fibers are typically present in the uncured ceramic article in an amount of from 5 to 25 parts by weight based on 100 parts by weight of solids in the uncured ceramic article. The ceramic fibers typically remain as solids in the ceramic article after curing or sintering. That is, the ceramic fibers are typically present in the ceramic article in an amount of from 3 to 15 parts by volume based on 100 parts by volume of the ceramic article. The ceramic fibers are more typically present in the ceramic article in an amount of from 5 to 10 parts by volume based on 100 parts by volume of the ceramic article. A specific example of a ceramic fiber that is suitable for the present invention is alumina-silica fiber, commercially available from Thermal Ceramics Inc. of Atlanta, Ga.

The ceramic particles typically provide the ceramic article with excellent stiffness and wear resistance and typically comprise an element from period 2, 3, or 4 of the periodic table of the elements. The ceramic particles more typically comprise an element from period 2 or 3 of the periodic table of the elements. Typically, the ceramic particles comprise silicon, oxygen, carbon, aluminum, or boron. The ceramic particles are typically selected from the group of silicon carbide, alumina, boron carbide, and combinations thereof.

The ceramic particles typically each have a diameter of from 5 to 50, more typically 5 to 30 μm. One skilled in the art typically selects ceramic particles having a reference dimension of from 5 to 10, i.e., a smaller ceramic particle, for applications requiring high strength and stiffness. In contrast, one skilled in the art typically selects ceramic particles having a reference dimension of from 10 to 30, i.e., a larger ceramic particle, for applications requiring high wear resistance. One skilled in the art typically combines smaller ceramic particles and larger ceramic particles for applications requiring high strength, stiffness, and wear resistance.

The ceramic particles are typically present in the uncured ceramic article in an amount of from 50 to 75, more typically 60 to 70 parts by weight based on 100 parts by weight of solids in the uncured ceramic article. The ceramic particles typically remain as solids in the ceramic article after curing or sintering. That is, the ceramic particles are typically present in the ceramic article in an amount of from 15 to 30 parts by volume based on 100 parts by volume of the ceramic article. The ceramic particles are more typically present in the ceramic article in an amount of from 22 to 28 parts by volume based on 100 parts by volume of the ceramic article. A specific example of a ceramic particle is silicon carbide, commercially available from Washington Mills of Niagara Falls, N.Y.

The ceramic article may further comprise a binder component. Without intending to be limited by theory, it is believed that the binder component provides the ceramic article with strength. The binder component typically comprises an organic binder and an inorganic binder. More specifically, without intending to be limited by theory, it is believed that the organic binder provides an uncured ceramic article with strength, whereas the inorganic binder provides the ceramic article with strength. That is, it is to be appreciated that portions of the organic binder may be burned off during curing of the uncured ceramic article.

The organic binder of the binder component typically comprises a first component and a second component. The first component is typically a starch. Without intending to be limited by theory, it is believed that the first component provides the uncured ceramic article with strength and reduces adhesion of the second component. The first component is typically present in the uncured ceramic article in an amount of from 1 to 10 parts by weight based on 100 parts by weight of solids in the uncured ceramic article. A specific example of a first component is starch, commercially available as Westar 3+ Cationic Starch from Wesbond Corporation of Wilmington, Del.

The second component of the organic binder typically comprises a cellulose ether. The cellulose ether typically exhibits reverse thermal gelation and provides lubricity during formation of the uncured ceramic article. Without intending to be limited by theory, it is believed that the cellulose ether also typically provides surface activity, plasticity, uniform rheology, and uniform distribution of air during formation of the uncured ceramic article. It is also believed that the cellulose ether also typically provides the uncured ceramic article with strength. The cellulose ether is typically selected from the group of methyl cellulose, hydroxypropylmethylcellulose, hydroxybutylmethylcellulose, and combinations thereof. The second component is typically present in the uncured ceramic article in an amount of from 0.5 to 10 parts by weight based on 100 parts by weight of solids in the uncured ceramic article. A suitable second component is hydroxypropylmethylcellulose, commercially available under the trade name Methocel™ A4M from The Dow Chemical Company of Midland, Mich.

The organic binder is typically present in the uncured ceramic article in an amount of from 0.5 to 25 parts by weight based on 100 parts by weight of solids in the uncured ceramic article.

The inorganic binder of the binder component is typically silica. Without intending to be limited by theory, it is believed that the inorganic binder provides the ceramic article with strength. The inorganic binder is typically present in the uncured ceramic article in an amount of from 2 to 10 parts by weight based on 100 parts by weight of solids in the uncured ceramic article. The inorganic binder typically remains as solids in the ceramic article after curing or sintering. That is, the inorganic binder is typically present in the ceramic article in an amount of from 2 to 5 parts by volume based on 100 parts by volume of the ceramic article. A suitable inorganic binder is silica, commercially available under the trade name Bindzil 1440 Colloidal Silica from Wesbond Corporation of Wilmington, Del.

The binder component is typically present in the uncured ceramic article in an amount of from 5 to 35 parts by weight based on 100 parts by weight of solids in the uncured ceramic article.

The uncured ceramic article may further comprise an additive component. The additive component typically comprises a filler. One skilled in the art typically selects the filler to control the density of the ceramic article. That is, the filler is typically included in the uncured ceramic article according to the weight percent of ceramic particles and ceramic fibers in the uncured ceramic article. The filler typically spaces out the ceramic particles and ceramic fibers to provide the ceramic article with desired density and to allow effective metal infiltration during formation of the metal matrix composite. The filler may be any filler known in the art. The filler is typically selected to burn off during heating, i.e., curing or sintering, of the ceramic article. The filler is typically selected from walnut shell flour, cellulose fiber, air, and combinations thereof. In one embodiment, the filler includes air to aid in curing the article 10 and to provide an open, porous article.

The filler is typically present in the uncured ceramic article in an amount of from 0.5 to 20 parts by weight based on 100 parts by weight of solids in the uncured ceramic article. A suitable filler is walnut shell flour, commercially available under from Ecoshell of Corning, Calif.

The additive component may further comprise an air entrainment agent. The air entrainment agent may be any air entrainment agent known in the art that is compatible with the second component of the binder component. One skilled in the art typically selects the air entrainment agent to increase air bubble content in the ceramic article and stabilize air bubble size to effect uniform air bubble distribution in the ceramic article. Without intending to be limited by theory, it is believed that the air entrainment agent decreases surface tension, optimizes dispersability, and contributes to the formation of fine, stable air bubbles to provide the open, porous article that is receptive to metal infiltration. The air entrainment agent is typically present in the uncured ceramic article in an amount of from 0.01 to 1 part by weight based on 100 parts by weight of solids in the uncured ceramic article. A suitable air entrainment agent is commercially available under the trade name Silipon® RN from Hercules of Wilmington, Del.

The additive component may further comprise a surfactant. The surfactant may be any known surfactant in the art that is compatible with the second component of the binder component. One skilled in the art typically selects the surfactant to lubricate the ceramic fibers and ceramic particles. The surfactant is typically present in the uncured ceramic article in an amount of from 0.01 to 1 part by weight based on 100 parts by weight of solids in the uncured ceramic article.

The additive component may further comprise a foam stabilizing agent. The foam stabilizing agent may be any known foam stabilizing agent in the art that is compatible with the second component of the binder component. One skilled in the art typically selects the foam stabilizing agent to minimize the formation of undesired air bubbles in the uncured ceramic article. The foam stabilizing agent is typically present in the uncured ceramic article in an amount of from 0.01 to 1 part by weight based on 100 parts by weight of solids in the uncured ceramic article.

The additive component is typically present in the uncured ceramic article in an amount of from 5 to 30 parts by weight based on 100 parts by weight of solids in the uncured ceramic article.

The method of controlling evaporation utilizes a film 22 and includes the step of encapsulating the article 10 with the film 22 to prevent the fluid from evaporating from the article 10. The term “encapsulate,” as used herein, is meant to be interpreted as encapsulating the article 10 with the film 22 such that there are not any surfaces or portions of surfaces of the article 10 exposed to the surrounding environment. It is to be appreciated, therefore, that if the article 10 is heated such that at least one surface of the article 10 is not exposed to the surrounding environment, e.g. on a plate or other platform, only the exposed portion of the article 10 must be covered by the film 22 to be considered “encapsulated.” The term “prevent,” as used herein, is meant to be interpreted as preventing at least 90 percent of the fluid in the article 10 from evaporating upon heating of the article 10 or at ambient temperatures. The film 22 also substantially prevents a fluid concentration gradient from an exterior to an interior of the article 10. In one embodiment, the film 22 is in contact with the surfaces of the article 10 such that there are no voids between the article 10 and the film 22, i.e., the film 22 is tightly adhered to the article 10.

It is to be appreciated that when the article 10 is independent of the mold 16, the step of encapsulating the article 10 with the film 22 may be performed in any manner known in the art, such as by an automated process, as shown in FIG. 4, or by manually wrapping the film 22, such that the step of encapsulating the article 10 with the film 22 can be performed independently from the step of depositing the extrudate 12 in the mold 16. Further, when the method includes the step of depositing the extrudate 12 in the mold 16, the step of encapsulating the article 10 with the film 22 may be performed prior to, contemporaneous with, i.e., simultaneously, or after depositing the extrudate 12 in the mold 16 and closing the mold 16 to shape the extrudate 12 into the article 10.

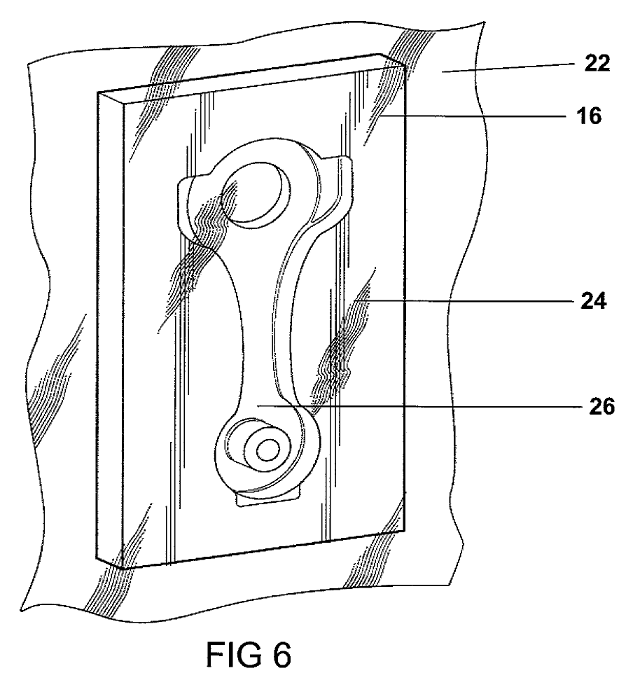

For example, as best shown in FIG. 6, the mold 16 may have a surface 24 defining an open mold cavity 26 having a shape. In this embodiment, the step of encapsulating the article 10 with the film 22 is performed simultaneously with the step of depositing the extrudate 12 in the mold 16 and closing the mold 16 to shape the extrudate 12 into the article 10. The step of encapsulating the article 10 with the film 22 may further comprise stretching the film 22 across the surface 24 of the mold 16 and the extrudate 12. The step of encapsulating the article 10 with the film 22 comprises the step of disposing the film 22 inside the mold 16. The step of disposing the film 22 inside the mold 16 can be performed by mechanically pressing the film 22 into the open mold cavity 26, thereby conforming the film 22 to the shape of the open mold cavity 26. It is to be appreciated that in addition to mechanically pressing, or alternatively to mechanically pressing, the step of disposing the film 22 in the mold 16 can comprise the step of vacuum forming, thermoforming, pressure forming, press forming, and combinations thereof. In addition, when the method includes the step of depositing the extrudate 12 in the mold 16, the step of encapsulating the article 10 with the film 22 may be performed prior to the step of depositing the extrudate 12 in the mold 16. Further, the steps of extruding the composition to form the extrudate 12 and processing the extrudate 12 are performed prior to encapsulating the article 10 with the film 22.

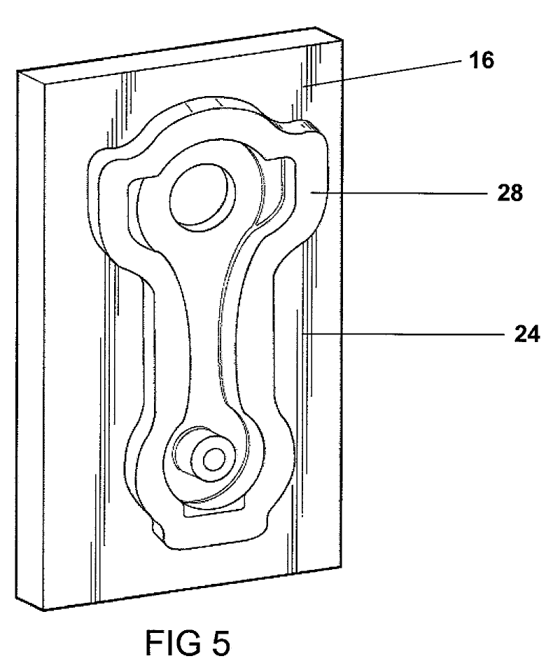

In one embodiment, the film 22 is a polymeric film. The film 22 may have any thickness, though it is to be appreciated that in one embodiment the thickness is such that the film 22 is flexible and elastic. It is to be appreciated that the film 22 may also have the thickness such that the film 22 is a rigid film 28. Further, the rigid film 28 may imitate the shape of the open mold cavity 26, as shown in FIG. 5, such that the article 10 is encapsulated with the rigid film 28 even after the article 10 is removed from the mold 16 while maintaining the shape of the open mold cavity 26. Alternatively, the rigid film 28 can be predisposed to having the shape of the open mold cavity 26 even when the method doesn't include the step of depositing the extrudate 12 or article 10 in the mold 16.

The film 22 is typically impermeable so as to prevent fluids from dispersing and/or osmosing therethrough. In one embodiment the polymeric film is a polyethylene; however, it is appreciated that the polymeric film can be any polymeric film, for example, polyether sulfone (PES), polyethylene terephthalate (PET), polyethylene naphtholate, polycarbonate, polybutylene terephthalate (PBT), polyphenylene sulfide (PPS), polypropylene, polyester, polyamide, polyimide, aromatic polyimide, polyetherimide, acrylonitrile butadiene styrene (ABS), polyvinyl chloride, vinylidene chloride, and combinations thereof. A particular example of a polyethylene film suitable for the present invention is Saran™ Premium Wrap, commercially available from S.C. Johnson of Racine, Wis.

It is to be appreciated that in addition to substantially preventing fluids, such as water, from evaporating from the extrudate 12 and/or article 10, the film 22 is employed to impart strength and support to the extrudate 12 and/or article 10. For example, when the extrudate 12 is deposited in the mold 16, the film 22 encapsulating the extrudate 12 will further support the extrudate 12. Further, after the molding process, the film 22 assists in retaining the shape of the article 10 such that the article 10 can be transported without becoming distorted, i.e., no longer retaining the shape of the open mold cavity 26.

After the step of encapsulating the article 10 with the film 22, the method includes the step of heating the article 10 to a first desired temperature of from 70 to 200, more typically from 100 to 140, most typically from 110 to 130° F. While heating the article 10 encapsulated with the film 22, the fluid is substantially prevented from evaporating from the article 10. The step of heating the article 10 to the first desired temperature is performed for a first period of time. The first period of time is typically of from 30 to 360, more typically from 60 to 300, most typically from 90 to 240 minutes.

In one embodiment of the present invention, the step of heating the article 10 to the first desired temperature comprises the step of heating the article 10 to the first desired temperature inside a heating chamber. The heating chamber may be an oven, a microwave, etc; however, it is to be appreciated that the heating chamber may be any heating chamber known in the art used to transfer heat to an object placed therein. It is to be appreciated that in the embodiment in which the method includes the step of depositing the article 10 in the mold 16, the method further comprises the step of placing the mold 16 in the heating chamber during the step of heating the article 10 to the first desired temperature. Alternatively, the step of heating the article 10 to the first desired temperature may be performed such that the mold 16 heats the article 10 to the first desired temperature independent of the heating chamber. For example, the mold 16 may have channels for a hot liquid, such as water, to pass through, thereby transferring heat to the article 10 and performing the step of heating the article 10 to the first desired temperature. Further, it is to be appreciated that in the embodiment in which the method includes the step of depositing the article 10 in the mold 16, the method can further include the step of removing the article 10 from the mold 16 prior to the step of heating the article 10 to the first desired temperature in the heating chamber.

It is to be appreciated that in the embodiment in which the article 10 is provided on, or subsequently wrapped around, the mandrel 14, the step of heating the article 10 to the first desired temperature is inside the heating chamber. Said differently, when the article 10 is provided on or wrapped around the mandrel 14, the mandrel 14 itself may act as the heating chamber for heating the article 10.

After the step of heating the article 10 to the first desired temperature, the method includes the step of removing the film 22, e.g. peeling the film 22, from the article 10 to allow the fluid to evaporate from the article 10. In the embodiment in which the film 22 is the rigid film 28, the rigid film 28 may be lifted or pulled from the article 10. In one embodiment of the present invention, the first desired temperature is a temperature at which the cellulose ether becomes gelatinous, i.e., a gel point temperature. In this embodiment, the first desired period of time is sufficient to allow for the cellulose ether to become fully gelatinous throughout the article 10. Once the gel point temperature of the cellulose ether has been attained, the film 22 is typically easily removed from the article 10 as the cellulose ether acts as a moist lubrication on the surface of the article 10. The film 22, whether the rigid film 28 or the film 22 that is flexible, can be removed from the article 10 without sticking thereto and/or damaging or distorting the article 10.

After the step of removing the film 22 from the article 10, the method further comprises the step of further heating the article 10 to a second desired temperature. The second desired temperature is typically of from 70 to 200, more typically from 100 to 160, most typically from 130 to 150° F. During the step of heating the article 10 to the second desired temperature, fluids, such as water, evaporate from the article 10. After the step of removing the film 22 from the article 10, the fluids can evaporate from the article 10 without having a distorting effect on the shape, structure, or consistency of the article 10. After the step of heating the article 10 to the first desired temperature, i.e., the gel point temperature of the cellulose ether, and the step of removing the film 22 from the article 10, the step of further heating the article 10 at the second desired temperature induces the fluids, such as water, to evaporate from the surface of the article 10 at an even rate and, additionally, the fluids migrate from within the article 10 to the surface of the article 10 at the even rate.

The step of further heating the article 10 to the second desired temperature is typically performed for a second period of time of from 4 to 72, more typically from 8 to 48, most typically from 12 to 36 hours. The second period of time is sufficient to allow substantially all off the fluids, such as water, to evaporate from the article 10. “Substantially all,” when used in reference to the fluids or water evaporating from the article 10 during the step of further heating the article 10 to the second desired temperature for the second period of time, is meant to be interpreted as typically at least 96, more typically at least 98, most typically at least 99 percent of the fluids or water within the article 10.

It is to be appreciated that in the embodiment in which the method includes the step of depositing the article 10 in the mold 16 and the step of heating the article 10 to the first desired temperature is performed while the article 10 is deposited in the mold 16, i.e., without use of a heating chamber, the method further comprises the step of removing the article 10 from the mold 16 prior to the step of further heating to the article 10 to the second desired temperature. When the method includes the step of depositing the article 10 in the mold 16 and the step of heating the article 10 to the first desired temperature takes place in the mold 16, the mold 16 does not negatively affect the article 10 because the fluids are prevented from evaporating therefrom. However, evaporation of the fluids are necessary to cure the article 10 during the step of further heating the article 10 to the second desired temperature, and thus the method further comprises the step of removing the article 10 from the mold 16 and the step of removing the film 22 from the article 10 prior to the step of further heating the article 10 to the second desired temperature. Though the step of heating the article 10 to the first desired temperature may take place independent of the heating chamber, i.e., by heating the mold 16 itself, the step of further heating the article 10 to the second desired temperature typically takes place in the heating chamber.

In one embodiment, the method further comprises the step of further heating the article 10 at a third desired temperature of from 400 to 800, more typically from 450 to 700, most typically from 475 to 525° F. In this embodiment, the step of further heating the article 10 to the third desired temperature is performed once the fluids, such as water, have been substantially evaporated from the article 10 during the step of further heating the article 10 at the second desired temperature. The step of further heating the article 10 at the third desired temperature is performed for a third period of time of from 15 to 180, more typically from 90 to 150, most typically from 105 to 135 minutes. The step of further heating the article 10 to the third desired temperature typically burns off the organic binder from within the article 10.

In one embodiment, the method further includes the step of further heating the article 10 at a fourth desired temperature of from 1500 to 2100, more typically from 1600 to 2000, most typically from 1700 to 1900° F. The step of further heating the article 10 at the fourth desired temperature is performed once the organic binder has been substantially burned off from the article 10 during the step of further heating the article 10 at the third desired temperature. The step of further heating the article 10 at the fourth desired temperature is typically performed for a fourth period of time of from 30 to 180, more typically from 90 to 150, most typically from 105 to 135 minutes. The step of further heating the article 10 to the fourth desired temperature typically sets the silica within the article 10, thereby forming a cured article, e.g. the cured ceramic article 20.

The present invention has been described herein in an illustrative manner, and it is to be understood that the terminology which has been used is intended to be in the nature of words of description rather than of limitation.

Obviously, many modifications and variations of the present invention are possible in light of the above teachings, and the invention may be practiced otherwise than as specifically described within the scope of the appended claims.

What is claimed is:

1. A method of controlling evaporation of a fluid from an article utilizing a film, said method including the steps of:
encapsulating the article with the film to prevent the fluid from evaporating from the article;
heating the article to a first desired temperature as the fluid is prevented from evaporating from the article for a first period of time;
removing the film from the article to allow the fluid to evaporate from the article; and
further heating the article to a second desired temperature for a second period of time sufficient to dry the article.

2. A method as set forth in claim 1 further including the step of extruding a composition to form the article.

3. A method as set forth in claim 1 further including the step of extruding a composition to form an extrudate.

4. A method as set forth in claim 3 further including the step of processing the extrudate to form the article.

5. A method as set forth in claim 4 wherein the steps of extruding and processing are performed prior to encapsulating the article with the film.

6. A method as set forth in claim 4 further including a mold and wherein the step of processing the extrudate is further defined as depositing the extrudate in the mold.

7. A method as set forth in claim 6 further including the step of closing the mold to shape the extrudate into the article.

8. A method as set forth in claim 7 wherein the step of encapsulating the article with the film is performed contemporaneously with the steps of depositing the extrudate in the mold and closing the mold to shape the extrudate into the article.

9. A method as set forth in claim 8 wherein the step of encapsulating the article with the film comprises the step of disposing the film inside the mold.

10. A method as set forth in claim 9 wherein the step of disposing the film inside the mold comprises the step of at least one of vacuum forming, thermoforming, mechanical pressing, pressure forming, and press forming.

11. A method as set forth in claim 9 wherein the step of disposing the film inside the mold is performed prior to the step of depositing the extrudate in the mold.

12. A method as set forth in claim 6 wherein the step of encapsulating the article with the film is performed independently from the step of depositing the extrudate in the mold.

13. A method as set forth in claim 1 wherein the article comprises ceramic fibers and further including the step of substantially randomly orienting the ceramic fibers in three dimensions in the article.

14. A method as set forth in claim 13 further including the step of extruding a composition to form the article and wherein the step of substantially randomly orienting the ceramic fibers is performed during the step of extruding the composition.

15. A method as set forth in claim 1 further including a mold and further including the step of forming the article within the mold.

16. A method as set forth in claim 15 wherein the step of heating the article to the first desired temperature comprises the step of heating the article to the first desired temperature inside a heating chamber.

17. A method as set forth in claim 16 wherein the step of heating the article to the first desired temperature comprises the step of heating the article to a temperature of from 70 to 200° F.

18. A method as set forth in claim 16 wherein the step of heating the article to the first desired temperature further comprises the step of removing the article from the mold such that the heating chamber is independent of the mold.

19. A method as set forth in claim 18 wherein the step of heating the article to the first desired temperature independent of the mold comprises the step of heating the article to a temperature of from 70 to 200° F.

20. A method as set forth in claim 1 wherein the step of encapsulating the article with the film comprises the step of encapsulating the article with a polymeric film.

21. A method as set forth in claim 20 wherein the step of encapsulating the article with the plastic film comprises the step of encapsulating the article with a polyethylene film.

22. A method as set forth in claim 1 wherein the step of heating the article to the first desired temperature comprises the step of heating the article to a temperature of from 70 to 200° F.

23. A method as set forth in claim 1 wherein the step of heating the article to the first desired temperature is performed for the first period of time of from 30 to 360 minutes.

24. A method as set forth in claim 1 wherein the step of heating the article to the second desired temperature comprises the step of heating the article to a temperature of from 70 to 200° F.

25. A method as set forth in claim 1 wherein the step of heating the article to the second desired temperature is performed for the second period of time of from 4 to 72 hours.

26. A method as set forth in claim 1 further comprising the step of heating the article to a third desired temperature of from 400 to 800° F. for a third period of time of from 15 to 180 minutes.

27. A method as set forth in claim 26 further comprising the step of heating the article to a fourth desired temperature of from 1500 to 2100° F. for a fourth period of time of from 30 to 180 minutes, thereby forming a cured article.
